(19) United States
(12) Patent Application Publication
(10) Pub. No.: US 2025/0005811 A1
(43) Pub. Date: Jan. 2, 2025

(54) METHOD, DEVICE, AND STORAGE MEDIUM FOR CONTENT GENERATION

(71) Applicant: Beijing Zitiao Network Technology Co., Ltd., Beijing (CN)

(72) Inventor: Hanyang CAI, Beijing (CN)

(21) Appl. No.: 18/755,461

(22) Filed: Jun. 26, 2024

(30) Foreign Application Priority Data
Jun. 27, 2023 (CN) 202310768519.3

(51) Int. Cl. G06T 11/00

(52) U.S. Cl. CPC G06T 11/00; G06T 2200/24

(57) ABSTRACT

According to embodiments of the present disclosure, a method, device, and storage medium for content generation are provided. The method includes: displaying a generation component for generating media content related to a role, the generation component comprising a plurality of generation portals; obtaining, via the generation component, description information associated with the role, wherein the description information corresponds to at least one of the plurality of generation portals; providing the description information to a first model to generate input information for a second model; and displaying, via the generation component, a set of media contents generated by the second model based on the input information. Accordingly, the embodiments of the present disclosure can efficiently generate media content associated with a role by using a generation component, thereby reducing the interaction difficulty for generating media content related to the role, and reducing the time cost.

### CROSS-REFERENCE OF RELATED APPLICATION(S)

This application claims priority to Chinese Patent Application No. 202310768519.3, filed Jun. 27, 2023, and entitled “METHOD, APPARATUS, DEVICE, AND STORAGE MEDIUM FOR CONTENT GENERATION”, which is incorporated herein by reference in its entirety.

### FIELD

Example embodiments of the present disclosure generally relate to the field of computers, and more particularly, to a method, apparatus, device, and computer-readable storage medium for content generation.

### BACKGROUND

With the development of computer standards, various forms of electronic devices can greatly enrich people's daily lives. For example, some electronic devices may provide a user with a virtual scene, and such a virtual scene may include various types of roles, for example, a role that the user may control, or a non-player role.

For a designer, when authoring a role, it is usually necessary to create demand information for the role designer, and such demand information may include, for example, a reference image, a reference sound and a reference video of the role.

### SUMMARY

In a first aspect of the present disclosure, a method for content generation is provided. The method comprises: displaying a generation component for generating media content related to a role, the generation component comprising a plurality of generation portals; obtaining, via a generation component, description information associated with a role; providing the description information to a first model to generate input information for a second model, wherein the description information corresponds to at least one generation portal of a plurality of generation portals; and displaying, via the generation component, a set of media contents generated by the second model based on the input information.

In a second aspect of the present disclosure, an apparatus for content generation is provided. The apparatus comprises: a component display module configured to display a generation component for generating media content related to a role, the generation component comprising a plurality of generation portals; an information acquisition module configured to obtain, via the generation component, description information associated with the role, wherein the description information corresponds to at least one of the plurality of generation portals; an information providing module configured to provide the description information to a first model to generate input information for a second model; and a content display module configured to display, via the generation component, a set of media contents generated by the second model based on the input information.

In a third aspect of the present disclosure, there is provided an electronic device. The electronic device includes at least one processing unit; and at least one memory coupled to the at least one processing unit and storing instructions for execution by the at least one processing unit. The instructions, when executed by the at least one processing unit, cause the electronic device to perform the method of the first aspect.

In a fourth aspect of the present disclosure, a computer readable storage medium is provided. The computer readable storage medium has a computer program stored thereon which is executable by a processor to implement the method in the first aspect.

It should be appreciated that what is described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages and aspects of various embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure can be implemented;

FIG. 2 illustrates a flowchart of a process for content generation according to some embodiments of the disclosure;

FIGS. 3A-3C illustrate schematic diagrams of content generation according to some embodiments of the disclosure;

FIG. 4 illustrates a schematic structural block diagram of an apparatus for content generation according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

It should be noted that the headings of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

In the description of the embodiments of the present disclosure, the term “include”, and the like should be understood as open-ended including, that is, “including but not limited to”. The term “based on” should be read as “based at least in part on.” The term “one embodiment” or “the embodiment” should be read as “at least one embodiment”. The term “some embodiments” should be understood as “at least some embodiments.” Other explicit and implicit claritys may also be included below. The terms “first”, “second”, etc. may refer to different or identical objects. Other explicit and implicit claritys may also be included below.

Embodiments of the present disclosure may relate to data, acquisition and/or use of data, etc. by a user, all following respective legal regulations and related regulations. In embodiments of the present disclosure, all data collection, acquisition, processing, processing, forwarding, use, and the like, are made with user knowledge and confirmation. Accordingly, when implementing the embodiments of the present disclosure, the user should be informed of the types of data or information that may be involved, a usage range, a usage scenario, and the like in an appropriate manner according to relevant legal regulations, and the authorization of the user is obtained. The specific informing and/or authorization manner may vary according to actual situations and application scenarios, and the scope of the present disclosure is not limited in this aspect.

In the present description and the embodiments, the personal information processing is performed on the basis of legitimacy (for example, the consent of the personal information body is obtained, or necessary for fulfillment of a contract, etc.), and is performed only within a predetermined range or a predetermined range. The user rejects personal information other than the necessary information required for processing the basic function, and the use of the basic function by the user is not affected.

Conventionally, in a role designing process, various types of information about a role are generally required and such information may include, for example, a reference appearance image, a reference costume image, and the like of the role. For example, a user may search a network for a reference image satisfying the requirements using a search tool. However, it leads to low efficiency and high time costs of the user.

Embodiments of the present disclosure propose a solution for content generation. According to various embodiments of the present disclosure, a generation component for generating media content associated with a role may be displayed. Such a generation component includes a plurality of generation portals, and description information associated with the role may be obtained via the generation component, where the description information corresponds to at least one of the plurality of generation portals. Further, the description information may be provided to a first model to generate input information for a second model. Accordingly, a set of media contents (e.g., text, pictures, audio, video, etc.) generated by the second model based on the input information may be displayed via the generation component.

Thus, embodiments of the present disclosure can efficiently generate media content associated with a role by using a generation component, thereby reducing the interaction difficulty for generating media content related to the role, and reducing the time cost.

### Example Environment

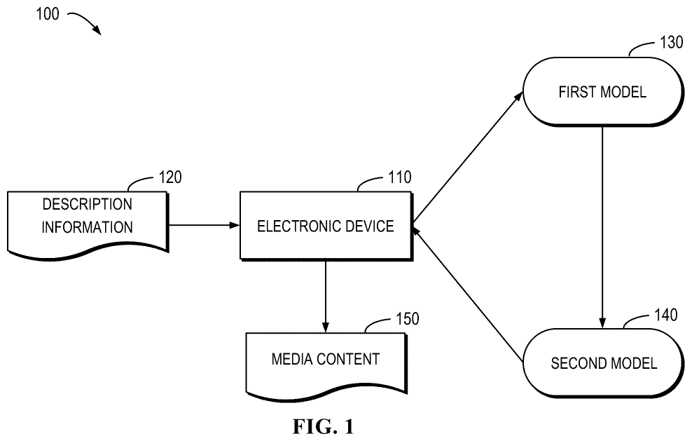

FIG. 1 shows a schematic diagram of an example environment 100 in which embodiments of the present disclosure can be implemented. As shown in FIG. 1, the example environment 100 can include an electronic device 110.

As shown in FIG. 1, the electronic device 110 may obtain description information 120 associated with a role. A specific example of such description information 120 will be described in detail below.

Further, the electronic device 110 can provide the description information 120 to a first model 130. For example, the first model 130 can, for example, include any suitable machine learning model, e.g., a language model. The first model 130 may generate input information for a second model 140 based on the description information 120.

As shown in FIG. 1, the second model 140 may generate media content 150 associated with the role based on the input information generated by the first model 130 and displayed to the user by the electronic device 110.

It should be appreciated that the input information may be provided by the first model 130 directly to the second model 140, for example, or the input information may be forwarded by the electronic device 110 or other device. For example, the electronic device 110 may obtain the input information generated by the first model 130 and further provide the input information to the second model 140 for the generation of the media content 150.

In some embodiments, such media content 150 may include textual content, image content, audio content, video content, or a combination thereof. For example, the media content 150 may include a reference image, reference video, reference dubbing, reference dialogue text of the role, etc.

In some embodiments, the second model 140 may include, for example, a suitable machine learning model, such as a media content generation model. Conventionally, such media content generation models require some specialized knowledge to perform model interaction, which is challenging for the role designers. Based on the embodiments of the present disclosure, input information to a media content generation model can be generated by using, for example, a language model, thereby reducing a learning cost of a role designer, so that the generation of media content related to a role can be completed by using a simpler interaction manner.

In some embodiments, first model 130 and/or second model 140 may be disposed locally on electronic device 110, for example, or at other suitable remote devices.

The electronic device 110 may be any type of mobile terminal, fixed terminal, or portable terminal, including a mobile phone, desktop computer, laptop computer, notebook computer, netbook computer, tablet computer, media computer, multimedia tablet, palmtop computer, portable game terminal, VR/AR device, Personal Communication System, a PCS) device, personal navigation device, personal digital assistant (PDA), audio/video player, digital camera/camcorder, positioning device, television receiver, radio broadcast receiver, electronic book device, game device, or any combination of the foregoing, including accessories and peripherals for these devices, or any combination thereof.

For example, the first model 130 and/or the second model 140 may be provided by an independent physical server, or may be provided by a server cluster or a distributed system formed by a plurality of physical servers, and may also be provided by a cloud server of a basic cloud computing service, such as a cloud service, a cloud database, cloud computing, a cloud function, cloud storage, a network service, cloud communication, a middleware service, a domain name service, a security service, a content delivery network, and a big data and artificial intelligence platform. Such servers may include, for example, computing systems/servers such as mainframes, edge computing nodes, computing devices in a cloud environment, etc.

A communication connection may be established between the server and the electronic device 110. The communication connection may be established in a wired manner or a wireless manner. Communication connections may include, but are not limited to, Bluetooth connections, mobile network connections, Universal Serial Bus (USB) connections, Wireless Fidelity (WiFi) connections, and the like, to which embodiments of the present disclosure are not limited.

It should be understood that the structure and function of the various elements in environment 100 are described for exemplary purposes only, and are not intended to imply any limitation on the scope of the disclosure.

Some example embodiments of the present disclosure will be described below with reference to the accompanying drawings.

### Example Processes

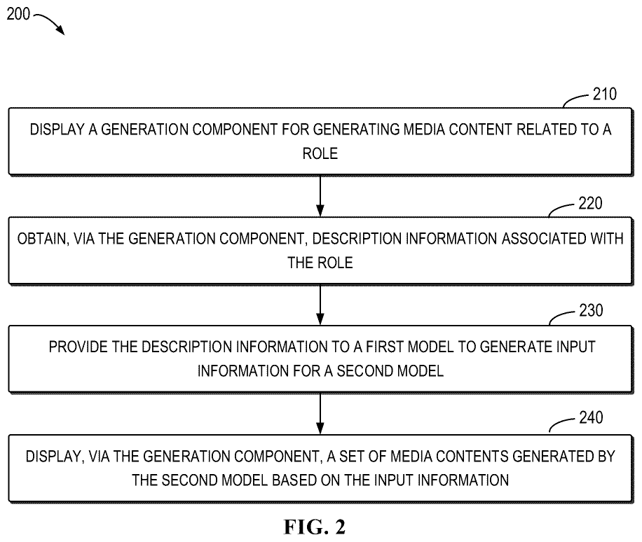

FIG. 2 illustrates a flowchart of a process 200 for content generation according to some embodiments of the disclosure. The process 200 may be implemented at the electronic device 110. For ease of discussion, the process 200 will be described with reference to environment 100 of FIG. 1.

At block 210, the electronic device 110 displays a generation component for generating media content related to a role, the generation component including a plurality of generation portals.

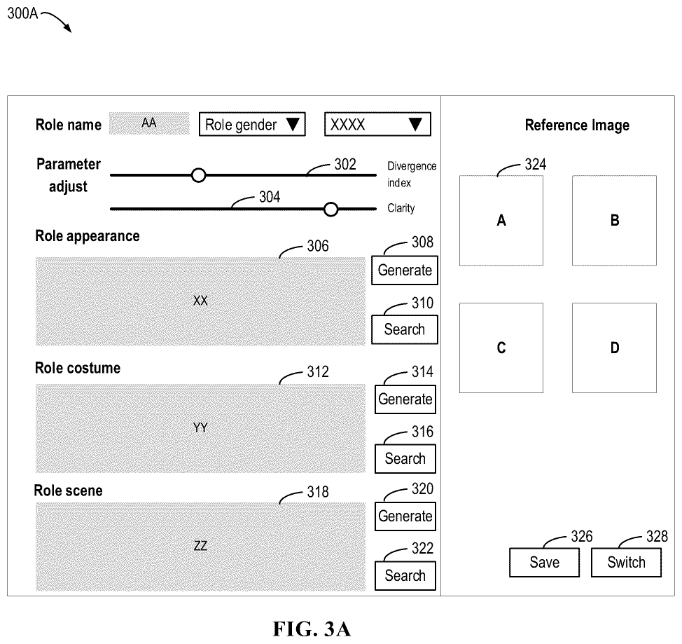

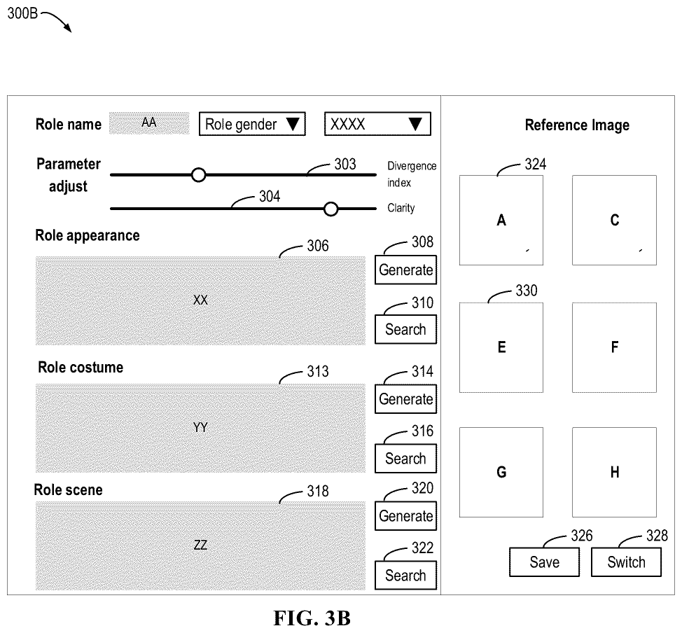

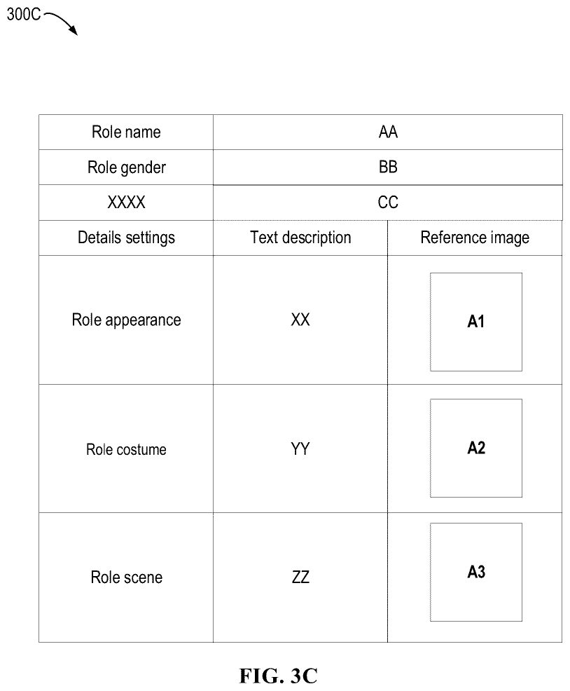

For ease of description, process 200 will be described below in connection with the examples of FIGS. 3A-3C. The examples of FIGS. 3A-3C are used to illustrate the process 200 with reference to the generation of image content, but it is to be understood that such a process may also be used for the generation of other suitable types of media content.

As shown in FIG. 3A, the electronic device 110 may, for example, display a generation component 300A. Such generation component 300A may, for example, be used to generate a reference image associated with a particular role.

Still referring to FIG. 2, at block 220, the electronic device 110 obtains, via a generation component, description information associated with the role, where the description information corresponds to at least one of a plurality of generation portals.

As shown in FIG. 3A, the generation component 300A may, for example, include a plurality of information portal controls to obtain various description information associated with the role. Such description information may include the role name, gender, etc. which are just examples, without implying any limitation.

Additionally, the generation component may also, for example, utilize the input component to retrieve appearance description information 306, costume description information 312, scene description information 318, etc., of the role. As an example, the appearance description information may be used, for example, to describe an appearance feature (for example, the facial feature) of the role to be created. Costume description information 312 may, for example, describe a costume feature for the role. The scene description information 318 may, for example, describe a representative scene for the role.

As an example, the user may input the description information of the role using one or more information input controls provided in the generation component 300A.

Further, the generating assembly 300A may also provide a plurality of generation portals. Taking FIG. 3 as an example, the generating assembly 300A may include a generation portal 308, a generation portal 314, and a generation portal 320.

For example, if the user selects the generation portal 308, the electronic device 110 may trigger generation of a corresponding appearance reference image based at least in part on the appearance description information 306. Where the user selects the generation portal 314, the electronic device 110 may trigger the generation of a corresponding costume reference image based at least in part on the costume description information 312. If a user selects the generation portal 320, the electronic device 110 may trigger generation of a corresponding scene reference image based at least in part on scene description information 320.

Still referring to FIG. 2, at block 230, the electronic device 110 provides the description information to the first model 130 to generate input information for the second model 140.

For example, where the user selects generation portal 308, electronic device 110 can provide corresponding description information to first model 130. Such description information may include, for example, appearance description information 306, and/or other description information of the role, such as, for example, the name of the role, the gender of the role, etc.

Further, the first model 130 may generate the input information to the second model 140 based on the obtained description information. The first model 130 may, for example, be implemented based on any suitable machine learning technique. The first model 130 may, for example, include a language model. The second model 140 may include, for example, a media content generation model implemented based on any suitable machine learning technique.

In some embodiments, the input information may, for example, correspond to other languages than description information. For example, the description information may be represented in a first language, such as Chinese, which may depend, for example, on the user input. Instead, the input information may be converted into a second language that is determined based on the second model 140.

Such second language may be, for example, a processing language of the second model 140, or a language in which the second model 140 can provide high processing capabilities, or a language specified by the second model 140, etc.

In this way, the embodiments of the present disclosure can allow a user to perform a description information input of a role in an appropriate language without bothering the user with the knowledge of the language on which the second model 140 depends.

In some embodiments, the first model 130 may also be pre-trained to have the capability to generate the input information for the second model 140. As an example, the first model 130 may be trained by providing appropriate input information samples, and the present disclosure is not intended to limit the training process of the first model 130.

In some embodiments, as shown in FIG. 3A, the generation component 300A may also include, for example, a parameter control 302 and a parameter control 304 for receiving the generated parameters. For example, the parameter control 302 may be used to input a divergence index that controls the generation of an image. For example, the higher the divergence index is, the more divergent the image is; and the lower the divergence index is, the higher matching degree of the description information the image has. The parameter control 302 can be used for inputting and controlling the clarity index of the generated image. For example, the higher the clarity index is, the higher the clarity level of the image is, but the generating process may be at a slower speed. As a contrast, the lower the sharpness index the lower the generated image sharpness, the faster the generating process may be.

Such generating parameters may also be provided to the first model 130 for the generation of input information. It should be understood that where the media content is different or the second model is different, the generating parameters of permitted inputs may also vary accordingly.

Still referring to FIG. 2, at block 240, the electronic device 110 displays, via the generation component, a set of media contents generated by the second model based on the input information.

Taking FIG. 3A as an example, electronic device 110 may, for example, obtain a set of images 324 generated by the second model. Based on such a manner, the embodiments of the present disclosure can improve the efficiency of the media content generation for the role, and reduce the cost of the user in model learning and interaction.

It should be understood that although FIG. 3A is described in the example of image generation, the embodiments of the present disclosure may also support other types of media content generation, e.g., text content, audio content, video content, etc., where the second model 140 has different generation capabilities.

In some embodiments, similar to the generation portal 308, the user can also generate a corresponding image by triggering the generation portal 314 and the generation portal 320.

For example, a user may input costume description information 312, and may trigger, by clicking on the generation portal 314, the first model 130 to generate input information for the second model 140 based on the costume description information 312 and/or other description information and/or the generating parameter for the role, thereby obtaining and displaying a costume reference image generated by the second model 140 based on the input information.

As another example, a user may input scene description information 318, and may trigger first model 130, by clicking the generation portal 320, to generate input information for the second model 140 based on article of costume description information 318 and/or other description information and/or the generating parameter of the role, thereby obtaining and displaying the scene reference image generated by the second model 140 based on the input information.

In such cases, the generation portal 308, generation portal 314, and/or generation portal 320 corresponding description information may have different information portions describing different aspects of the role. For example, the description information corresponding to the generation portal 308 may include appearance description information 306 for the role appearance, the description information corresponding to the generation portal 314 may include costume description information 312 for the role costume, and the description information corresponding to the generation portal 320 may include scene description information 318 for the role scene.

In some embodiments, the image content generated by the second model 140 may be presented in the generation component 300A. Taking FIG. 3A as an example, the electronic device 110 may present a set of images 324 generated by the second model 140 in the generation component 300A. Such a set of images 324 may include one or more images.

In some embodiments, the generation component 300A may also, for example, include a regeneration portal 328. Upon receiving a request to regenerate media content, e.g., receiving a selection for the regeneration portal 328, the electronic device 110 may, for example, trigger the second model to regenerate a set of images, and can display the set of regenerated images accordingly.

In further embodiments, the generation component 300A may also, for example, support a user to select and save one or more images of the set of images 324. As an example, the user may, for example, select ‘Image A’ and ‘Image C’ and save the selected images through the save control 326. In this case, the regenerating request from the user will cause overwriting of the saved images.

As an example, FIG. 3B shows an example generation component according to some embodiments of the present disclosure. For example, the user, while holding “Image A” and “Image C” in the original set of images 324, further triggers the regeneration portal 328. In this case, the electronic device 110 will further display the set of regenerated images 330 while saving the display of “Image A” and “Image C.”.

In still other embodiments, as shown in FIG. 3A, the electronic device 110 can also provide the retrieval portal 310, the retrieval portal 316, and/or the retrieval portal 322 via the generation assembly 300A.

In contrast to the generating process discussed above, where, for example, the retrieval portal 310 is selected, the electronic device 110 can provide description information corresponding to the retrieval portal 310 to the first model 130 for generating query information to a search tool.

Such a search tool may include, for example, any suitable retrieval platform (e.g., a retrieval website, a retrieval service, etc.). The first model 130 may, for example, generate a search query to a corresponding search tool based on the description information.

Further, such query may be provided by the first model 130 directly to the search tool, or forwarded by the electronic device 110 and/or other device to the search tool. Accordingly, the electronic device 110 may display a set of media contents obtained using the search tool and based on the query information. For example, such a set of media contents may include a set of images obtained based on an image search tool.

In this way, the embodiments of the present disclosure can not only provide the user with the capability of generating content, but also provide the user with the capability of retrieving content, thereby improving the efficiency of the user in using the generation component.

In some embodiments, the generation component may also support automated generation of the demand information. As an example, after inputting various types of role description information and selecting one or more pieces of media content from the recommended reference media content, the user may trigger automatic generation of the demand information.

FIG. 3C illustrates example demand information 300C according to some embodiments of the present disclosure. As illustrated in FIG. 3C, such demand information 300C may include description information input by a user, e.g., a role name, a role gender, appearance description information, costume description information, scene description information, etc.

Such demand information 300C may also, for example, include at least one media content selected by the user, e.g., a reference image selected by the user for role appearance, a reference image(s) selected for role costume, a reference image(s) selected for a role scene.

Such demand information may further be provided, for example, to a stylistic designer of the role for completion of the next design of the role. In this manner, embodiments of the present disclosure can further improve the efficiency of role authoring.

It should be understood that, although the example generation component is described in the foregoing with reference to an image as an example of media content, the embodiments of the present disclosure may also be applicable to other generation of proper media content, for example, generation of a role reference audio, generation of a role reference video, generation of a role reference dialog text, and the like, which are not described herein again.

In addition, the specific interface layout in the foregoing generation component, the number of generating controls, and the aspect involved in the role description information are only exemplary. Without departing from the spirit of the present disclosure, description information associated with other aspects of the role can be obtained according to actual needs for generation and/or retrieval of relevant media content.

### Example Apparatus and Device

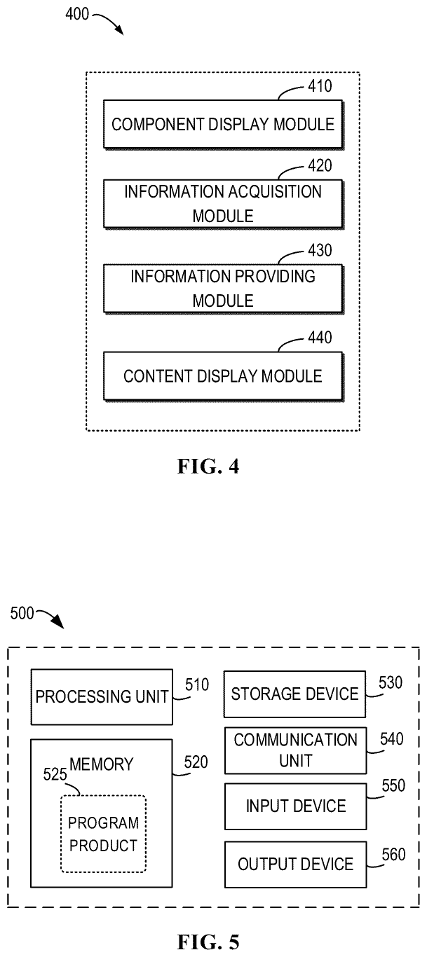

Embodiments of the present disclosure also provide corresponding means for implementing the methods or processes described above. FIG. 4 illustrates a schematic structural block diagram of an apparatus 400 for content generation according to certain embodiments of the present disclosure. The apparatus 400 may be implemented as or included in a device as discussed above. The various modules/components in the apparatus 400 may be implemented by hardware, software, firmware, or any combination thereof.

As shown in FIG. 4, the apparatus 400 includes a component display module 410 configured to display a generation component for generating media content associated with a role, the generation component including a plurality of generation portals; an information acquisition module 420 configured to obtain, via the generation component, description information associated with the role, wherein the description information corresponds to at least one of the plurality of generation portals; an information providing module 430 configured to provide the description information to a first model to generate input information for a second model; and a content display module 440 configured to display, via the generation component, a set of media contents generated by the second model based on the input information.

In some embodiments, the information acquisition module 420 is further configured to obtain, via the generation component, a generating parameter associated with a generating process; and the information providing module 430 is further configured to provide the generating parameter to the first model for use in generating the input information.

In some embodiments, the set of media contents is a first set of media contents, and the content display module 440 is further configured to display, based on the request to regenerate the media content, a second set of media contents generated by the second model based on the input information.

In some embodiments, the content display module 440 is further configured to: receive a selection of a target media content of the first set of media content; and continue displaying of the target media content of the first set of media contents with the second set of media content displayed.

In some embodiments, the plurality of generation portals include at least a first generation portal and a second generation portal, and the information providing module 430 is further configured to in response to a selection of the first generation portal, provide first description information corresponding to the first generation portal to the first model.

In some embodiments, the information provision module 440 is further configured to in response to a selection for the second generation portal, provide to the first model, second description information corresponding to the second generation portal, where the first description information and the second description information include at least different information portions describing different aspects of the role.

In some embodiments, the generation component further includes a search portal, and the apparatus 400 further comprises a search module configured to: in response to a selection for the search portal, provide the description information to the first model for use in generating query information for a search tool; and display a third set of media contents obtained by the search tool based on the query information.

In some embodiments, the apparatus 400 further comprises a demand generation module configured to generate demand information associated with the role based on the description information and at least one selected media content of the set of media contents.

In some embodiments, the description information corresponds to a first language and the input information corresponds to a second language different from the first language, the second language determined based on the second model.

The units included in apparatus 400 may be implemented in a variety of ways, including software, hardware, firmware, or any combination thereof. In some embodiments, one or more units may be implemented using software and/or firmware, such as machine-executable instructions stored on a storage medium. In addition to or instead of machine-executable instructions, some or all of the units in apparatus 400 may be implemented, at least in part, by one or more hardware logic components. By way of example, and not limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

FIG. 5 illustrates a block diagram of an electronic device 500 in which one or more embodiments of the present disclosure may be implemented. It should be appreciated that the electronic device 500 shown in FIG. 5 is merely exemplary and should not constitute any limitation on the functionality and scope of the embodiments described herein. The electronic device 500 shown in FIG. 5 may be used to implement the electronic device 110 shown in FIG. 1.

As shown in FIG. 5, the electronic device 500 is in the form of a general electronic device. The components of the electronic device 500 may include, but are not limited to, one or more processors or processing units 1205, a memory 520, a storage device 530, one or more communication units 540, one or more input devices 550, and one or more output devices 560. The processing unit 1205 may be an actual or virtual processor and can perform various processes according to the programs stored in the memory 520. In a multiprocessor system, multiple processing units can execute computer executable instructions in parallel to improve the parallel processing capability of the electronic device 500.

The electronic device 500 typically includes a variety of computer storage medium. Such medium may be any available medium that is accessible to electronic device 500, including, but not limited to, volatile and non-volatile medium removable and non-removable medium. The memory 520 may be volatile memory (e.g., registers, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium such as a flash drive, a magnetic disk, or any other medium that can be used to store information and/or data (e.g., training data for training) and that can be accessed within the electronic device 500.

The electronic device 500 may further include additional removable/non-removable, volatile/nonvolatile storage medium. Although not shown in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data medium interfaces. The memory 520 may include a computer program product 525 having one or more program modules configured to perform various methods or behaviors of the various embodiments of the present disclosure.

The communication unit 540 communicates with other electronic devices through the communication medium. In addition, functions of components of the electronic device 500 may be implemented by a single computing cluster or a plurality of computing machines, and these computing machines can communicate through a communication connection. Thus, the electronic device 500 may operate in a networking environment using logical connections to one or more other servers, network personal computers (PCs), or another network node.

The input device(s) 550 may be one or more input devices such as a mouse, keyboard, trackball, etc. Output device(s) 560 may be one or more output devices such as a display, speakers, printer, etc. The electronic device 500 may also communicate with one or more external devices (not shown) through the communication unit 540 as required, such as a storage device, a display device, etc., with one or more devices that enable a user to interact with the electronic device 500, or with any device (e.g., a network card, a modem, etc.) that enables the electronic device 500 to communicate with one or more other electronic devices. Such communication may be performed via an input/output (I/O) interface (not shown).

According to example implementations of the present disclosure, a computer-readable storage medium is provided, on which a computer-executable instruction is stored, wherein the computer-executable instruction is executed by a processor to implement the above-described method. According to an example implementation of the present disclosure, there is also provided a computer program product, which is tangibly stored on a non-transitory computer-readable medium and includes computer-executable instructions that are executed by a processor to implement the method described above.

Various aspects of the present disclosure are described herein with reference to flowchart and/or the block diagrams of the methods, apparatus, devices and computer program products implemented in accordance with the present disclosure. It will be understood that each block of the flowchart and/or block diagrams, and the combinations of blocks in the flowchart and/or the block diagrams, can be implemented by computer-readable program instructions.

These computer-readable program instructions may be provided to a processing unit of a general purpose computer, special purpose computer, or other programmable data processing apparatus to produce a machine, such that the instructions, which execute via the processing unit of the computer or other programmable data processing apparatus, create means for implementing the functions/acts specified in the flowchart and/or block diagram block or blocks. These computer-readable program instructions may also be stored in a computer-readable storage medium that can direct a computer, programmable data processing apparatus, and/or other devices to function in a particular manner, such that the computer-readable medium storing the instructions includes an article of manufacture including instructions which implement various aspects of the functions/acts specified in the flowchart and/or block diagram block or blocks.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is exemplary, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method for content generation, comprising:
displaying a generation component for generating media content related to a role, the generation component comprising a plurality of generation portals;
obtaining, via the generation component, description information associated with the role, wherein the description information corresponds to at least one of the plurality of generation portals;
providing the description information to a first model to generate input information for a second model; and
displaying, via the generation component, a set of media contents generated by the second model based on the input information.

2. The method of claim 1, further comprising:
obtaining, via the generation component, a generating parameter associated with a generating process; and
providing the generating parameter to the first model for use in generating the input information.

3. The method of claim 1, wherein the set of media contents is a first set of media contents, the method further comprising:
displaying, based on the request to regenerate the media content, a second set of media contents generated by the second model based on the input information.

4. The method of claim 3, wherein displaying a second set of media contents generated by the second model based on the input information comprises:
receiving a selection for a target media content in the first set of media content; and
continuing displaying of the target media content of the first set of media contents with the second set of media content displayed.

5. The method of claim 1, wherein the plurality of generation portal comprise at least a first generation portal and a second generation portal, and providing the description information to a first model comprises:
in response to a selection of the first generation portal, providing first description information corresponding to the first generation portal to the first model; or
in response to a selection for the second generation portal, providing the first model with second description information corresponding to the second generation portal, wherein the first description information and the second description information comprise at least different information portions describing different aspects of the role.

6. The method of claim 1, wherein the generation component further comprises a search portal, the method further comprising:
in response to a selection for the search portal, providing the description information to the first model for use in generating query information for a search tool; and
displaying a third set of media contents obtained by the search tool based on the query information.

7. The method of claim 1, further comprising:
generating demand information associated with the role based on the description information and at least one selected media content of the set of media contents.

8. The method of claim 1, wherein the description information corresponds to a first language and the input information corresponds to a second language different from the first language, the second language being determined based on the second model.

9. The method of claim 1, wherein the set of media contents comprises at least one of the following:
text content, image content, audio content, or video content.

10. An electronic device, comprising:
at least one processing unit; and
at least one memory coupled to the at least one processing unit and storing instructions for execution by the at least one processing unit that, when executed by the at least one processing unit, cause the electronic device to perform acts comprising:
displaying a generation component for generating media content related to a role, the generation component comprising a plurality of generation portals;
obtaining, via the generation component, description information associated with the role, wherein the description information corresponds to at least one of the plurality of generation portals;
providing the description information to a first model to generate input information for a second model; and
displaying, via the generation component, a set of media contents generated by the second model based on the input information.

11. The electronic device of claim 10, wherein the acts further comprise:
obtaining, via the generation component, a generating parameter associated with a generating process; and
providing the generating parameter to the first model for use in generating the input information.

12. The electronic device of claim 10, wherein the set of media contents is a first set of media contents, the acts further comprising:
displaying, based on the request to regenerate the media content, a second set of media contents generated by the second model based on the input information.

13. The electronic device of claim 12, wherein displaying a second set of media contents generated by the second model based on the input information comprises:
receiving a selection for a target media content in the first set of media content; and
continuing displaying of the target media content of the first set of media contents with the second set of media content displayed.

14. The electronic device of claim 10, wherein the plurality of generation portal comprise at least a first generation portal and a second generation portal, and providing the description information to a first model comprises:
in response to a selection of the first generation portal, providing first description information corresponding to the first generation portal to the first model; or
in response to a selection for the second generation portal, providing the first model with second description information corresponding to the second generation portal, wherein the first description information and the second description information comprise at least different information portions describing different aspects of the role.

15. The electronic device of claim 10, wherein the generation component further comprises a search portal, the acts further comprising:
in response to a selection for the search portal, providing the description information to the first model for use in generating query information for a search tool; and
displaying a third set of media contents obtained by the search tool based on the query information.

16. The electronic device of claim 10, wherein the acts further comprise:
generating demand information associated with the role based on the description information and at least one selected media content of the set of media contents.

17. The electronic device of claim 10, wherein the description information corresponds to a first language and the input information corresponds to a second language different from the first language, the second language being determined based on the second model.

18. The electronic device of claim 10, wherein the set of media contents comprises at least one of the following:
text content, image content, audio content, or video content.

19. A non-transitory computer readable storage medium having a computer program stored thereon which, when executed by a processor, to cause the processor to perform acts comprising:
displaying a generation component for generating media content related to a role, the generation component comprising a plurality of generation portals;
obtaining, via the generation component, description information associated with the role, wherein the description information corresponds to at least one of the plurality of generation portals;
providing the description information to a first model to generate input information for a second model; and
displaying, via the generation component, a set of media contents generated by the second model based on the input information.

20. The non-transitory computer readable storage medium of claim 19, wherein the acts further comprise:
obtaining, via the generation component, a generating parameter associated with a generating process; and
providing the generating parameter to the first model for use in generating the input information.
